(19) United States
(12) Patent Application Publication
(10) Pub. No.: US 2021/0106038 A1
(43) Pub. Date: Apr. 15, 2021

(54) NUTRITIONAL COMPOSITION

(71) Applicant: SOCIETE DES PRODUITS NESTLE S.A., Vevey (CH)

(72) Inventors: Timothy James Wooster, Epalinges (CH); Axel Syrbe, Clarens (CH); Elyes Ben Sassi, Lausanne (CH); Ludovic Penseyres, Corseaux (CH); Olivier Schafer, Epalinges (CH)

(21) Appl. No.: 17/044,032

(22) PCT Filed: May 21, 2019
(86) PCT No.: PCT/EP2019/063032

§ 371 Date: Sep. 30, 2020

(30) Foreign Application Priority Data
May 22, 2018 (EP) 18173567.1

(51) Int. Cl. A23L 33/115; A23L 33/16; A23L 33/17; A23L 33/125; A23L 33/00; A23L 29/10; A23D 7/01

(52) U.S. Cl. CPC A23L 33/115; A23L 33/16; A23L 33/17; A23V 2002/00; A23L 33/40; A23L 29/10; A23D 7/011; A23L 33/125

(57) ABSTRACT

A nutritional composition comprising soluble calcium, wherein 0.005 to 20 wt % of the lipids in said composition are polar lipids, wherein the polar lipids comprise one or more glycolipid.

### FIELD OF THE INVENTION

The present invention relates to nutritional compositions such as infant formulas comprising polar lipid emulsifiers. The present invention also relates to the use of polar lipid emulsifiers for enhancing the physical stability of a nutritional composition in the presence of soluble calcium.

### BACKGROUND TO THE INVENTION

Minerals are an essential part of the human diet. Sufficient quantities of most minerals can normally be obtained from a well-balanced diet. However, many people cannot consume a normal well-balanced diet, therefore nutritional compositions which comprise mineral supplements can be beneficial to many. One such mineral is calcium, which is important for the building and protection of bones and teeth and for preventing osteoporosis. Calcium is also needed for muscle, heart and digestive system health and supports the synthesis and function of blood cells.

Calcium deficiency in children leads to inadequate growth and bone deformity. To supply vital nutrients to infants, including calcium, mother's milk is recommended for all infants as a sole source of nutrition for up to 4-6 months of age. However, in some cases breastfeeding is inadequate or unsuccessful, inadvisable for medical reasons, or the mother chooses not to breast feed. Infant formulations have been developed for these situations, and should provide a minimum calcium content of 50 mg/100 kcal (Panel, EFSA NDA. “Scientific opinion on the essential composition of infant and follow-on formulae.” EFSA J 12 (2014): 3760).

The requirement for calcium in nutritional compositions, such as infant formulas, results in them undergoing aggregation due to loss of the emulsion stability. Most infant formulas and nutritional compositions will experience physical separation at low pH and high mineral content without the presence of buffers such as phosphates and emulsifiers. The physical separation is often referred to as creaming, flocculation, curdling, clumping, aggregation or sedimentation. This phenomenon is related first to the discharge of emulsion droplets then the aggregation of the droplets. As well as phase separation, creaming and clumping, an unstable emulsion may also cause lipid oxidation and nutrient degradation. For a nutritional composition these are all undesirable properties, which are particularly problematic for long-term storage.

Insoluble forms of calcium such as calcium phosphate are currently used to prevent calcium the flocculation/aggregation in nutritional compositions. However, insoluble forms of calcium have limited bioavailability and hence require overdosing within the product to ensure adequate calcium absorption. Furthermore, the preparation methods of some insoluble forms of calcium lead to very small particle sizes, potentially below 100 nm. The presence of very small particle sizes of insoluble calcium, and the incomplete bioavailability of insoluble forms of calcium, are listed by consumers and health care practitioners as one of the key ingredients that consumers have concerns about.

Thus, there is a demand for nutritional compositions which comprise free/soluble calcium, but which are also physically stable/free from droplet aggregation.

### SUMMARY OF THE INVENTION

The inventors have surprisingly found that polar lipids, such as those derived from oat, can be used as effective emulsifiers in calcium containing nutritional compositions. The polar lipids create a highly stable emulsion that reduces the need for insoluble calcium, synthetic emulsifiers and/or calcium chelation agents.

The inventors have also discovered that processing oat oil using low temperature high vacuum distillation lead to an oat oil that has substantially no odour or dark colour and is surprisingly able to stabilise nutritional emulsions without the addition of buffering agents, protein emulsifiers or synthetic emulsifiers. This has significant benefits over existing methods of bleaching and deodorising of the oil at elevated temperatures which creates a black pigment/gum leading to spoilage of the oil blend and the creation of an unappealing burnt/caramel aroma and taste.

The inventors have also surprisingly found that emulsions made using a combination of glycolipids and phospholipids do not inhibit or slow fat digestion thereby allowing the creation of natural emulsion based nutritional compositions that do not have negative nutritional consequences.

According to the present invention, there is provided a nutritional composition comprising (a portion of) soluble calcium, wherein at least 0.005 wt % of the lipids in said composition are polar lipids and wherein the polar lipids comprise a glycolipid.

In one embodiment, at least at least 0.01 wt %, at least 0.05 wt %, at least 0.1 wt %, at least 1.0 wt %, at least 2.0 wt % or at least 3.0 wt % of the lipids in said nutritional composition are polar lipids.

In one embodiment, 0.005 to 15 wt % of the lipids in said composition are polar lipids.

For example, 0.01 to 15 wt %, 0.05 to 15 wt %, 0.1 to 15 wt %, 0.5 to 15 wt %, 1 to 15 wt %, 2 to 15 wt %, 0.01 to 12 wt %, 0.05 to 12 wt %, 0.1 to 12 wt %, 0.5 to 12 wt %, 1 to 12 wt %, 2 to 15 wt %, 0.01 to 10 wt %, 0.05 to 10 wt %, 0.1 to 10 wt %, 0.5 to 10 wt %, 1 to 10 wt %, 2 to 10 wt %, 0.01 to 8 wt %, 0.05 to 8 wt %, 0.1 to 8 wt %, 0.5 to 8 wt %, 1 to 8 wt %, or 2 to 8 wt % of the lipids in said composition may be polar lipids.

Preferably, at least 5%, 10%, 15%, 20%, 30% or 40 wt % of the polar lipids are glycolipids.

Preferably, at least 5%, 10%, 15%, 20, 30% or 40 wt % of the polar lipids are galactolipids.

Preferably, at least 5%, 10%, 15% or 20 wt % of the polar lipids are digalactosyldiacylglycerides

In an embodiment, the composition comprises 0.005 to 1% (weight/weight) glycolipids, for example 0.005 to 1% (weight/weight) glycolipids derived from oat. For example the composition may comprise 0.008 to 0.09% (weight/weight) glycolipids, for example 0.008 to 0.09% (weight/weight) glycolipids derived from oat.

In an embodiment, the composition comprises 0.005 to 1% (weight/weight) digalactosyldiacylglycerides, for example comprises 0.005 to 1% (weight/weight) digalactosyldiacylglycerides derived from oat. For example the composition may comprise 0.007 to 0.08% (weight/weight) digalactosyldiacylglycerides, for example 0.007 to 0.08% (weight/weight) digalactosyldiacylglycerides derived from oat.

The polar lipids may also comprise phospholipids.

In one embodiment, less than 85, 80, 60, 40, 20, 15, 10, 8, 6, 4 or 2 wt % of the polar lipids may be phospholipids.

Preferably the polar lipids comprise at least 15 wt % phospholipids. In one embodiment, the polar lipids comprise at least 16, 17, 18, 19 or 20 wt % phospholipids.

For example, the polar lipids may comprise 15 to 85 wt % phospholipids or 20 to 80 wt % phospholipids.

In one embodiment the lipids may comprise glycolipids and phospholipids at a weight ratio of at least 1:5 glycolipids to phospholipids, for example at least 1:4, at least 1:3, at least 1:2 or at least 1:1.5. The lipids may comprise glycolipids and phospholipids at a weight ratio of 1:5 to 3:1, for example about 1:4 to 2:1 or 1:3 to 1:1.

The quantity of glycolipids and phospholipids may be determined by, for example, quantitative 31P-NMR (phospholipids) and quantitative 1H-NMR (glycolipids) with internal standards.

The polar lipids may be from edible plants. The polar lipids may be obtained from plants selected from the group consisting of oats; legumes (e.g., common bean, pea); leaf vegetables (e.g., kale, leek, parsley, perilla and spinach); stem vegetables (e.g., asparagus, broccoli, Brussels sprouts); and fruit vegetables (e.g., chili, bell pepper, pumpkin). The polar lipids may be example fractionated oils e.g., fractionated oat, legume; leaf vegetable, stem vegetable or fruit vegetable oil.

The polar lipids may be derived from oat, spinach (e.g. spinach leaf) or sweet potato (e.g. sweet potato leaf). Preferably the polar lipids are derived from oat. The polar lipids may be from oat oil, for example fractionated oat oil.

In a preferred embodiment, the oils derived from oat, spinach or sweet potatoes are prepared by low temperature high vacuum distillation.

In one embodiment, 0.1 to 30 wt % of the lipids in said composition are from oat oil, and at least 4%, at least 15%, at least 35% or at least 40 wt % of the oat oil lipids are polar lipids, wherein the polar lipids comprise one or more glycolipids.

In one embodiment, 0.5 to 30 wt %, 1 to 20 wt % or 2 to 15 wt % of the lipids in said composition are from oat oil, and at least 4%, at least 15%, at least 35% or at least 40 wt % of the oat oil lipids are polar lipids, wherein the polar lipids comprise one or more glycolipids

The source of calcium may be selected from the group consisting of calcium citrate, calcium hydroxide, calcium oxide, calcium chloride, calcium carbonate, calcium gluconate, calcium phosphate, calcium diphosphate, calcium triphosphate, calcium glycerophosphate, calcium lactate, and calcium sulphate.

In one embodiment, the soluble calcium is present between 10 to 120% of the ESPHGAN range for infant formula (i.e. 50 and 140 mg/100 kcal), for example between 5 to 180 mg/100 kcal, 5 to 160 mg/100 kcal, 5 to 140 mg/100 kcal, 5 to 100 mg/100 kcal, 5 to 75 mg/100 kcal, 5 to 50 mg/100 kcal, 10 to 140 mg/100 kcal, 20 to 140 mg/100 kcal, 30 to 140 mg/100 kcal, 40 to 140 mg/100 kcal or 50 to 140 mg/100 kcal.

In one embodiment, the nutritional composition comprises no additional non proteinaceous surface active emulsifiers, that is no surface active emulsifiers other than the polar lipids described herein and the proteins/amino acids required to provide complete nutrition.

In one embodiment, the nutritional composition comprises no additional non proteinaceous emulsifiers, that is no emulsifiers other than the polar lipids described herein.

In one embodiment, the total lipid in the composition is present in an amount of from 1 to 8 g/100 kcal, the total protein in the composition is present in an amount of from 1 to 12 g/100 kcal and/or the total carbohydrate in the composition is present in an amount of from is 8 to 20 g/100 kcal.

In a preferred embodiment, the nutritional composition is a ready-to-drink or ready to use beverage.

In another preferred embodiment, the nutritional composition is an infant formula or a follow-on formula. The infant formula or follow-on formula may be in liquid or powder form.

In one embodiment, the amount of total lipids in the infant formula is from 4.4 to 6.0 g/100 kcal.

In one embodiment, the total amount of protein in the infant formula is from 1.6 to 4 g/100 kcal.

In one embodiment, the total amount of carbohydrate in the infant formula is from 9 to 14 g/100 kcal.

In one embodiment, the amount of total lipids in the infant formula is from 4.4 to 6.0 g/100 kcal, the total amount of protein in the infant formula is from 1.6 to 4 g/100 kcal, and/or the total amount of carbohydrate in the infant formula is from 9 to 14 g/100 kcal.

According to another aspect of the present invention there is provided use of a polar lipid as defined herein as an emulsifier in a nutritional composition.

According to the use of the present invention the polar lipid is preferably oat oil, spinach oil or sweet potato oil as defined herein.

There is provided herein the use of oat oil, spinach oil or sweet potato oil as an emulsifier in a nutritional composition.

Preferably, the oat oil, spinach oil or sweet potato oil is prepared using low temperature high vacuum distillation, preferably low temperature high vacuum distillation.

According to the use of the present invention the polar lipid is preferably used to reduce acid and/or mineral (calcium) instability of a nutritional composition.

Thus, there is provided use of polar lipids as defined herein to reduce acid and/or mineral (calcium) instability of a nutritional composition.

In one embodiment, there is provided use of oat oil, spinach oil or sweet potato oil to reduce acid instability of a nutritional composition.

According to another aspect of the present invention there is provided a process for producing a nutritional composition of the present invention comprising the steps of:

(i) providing an aqueous phase;
(ii) providing an oil phase by mixing a source of polar lipids as defined herein with an oil;
(iii) combining the aqueous phase and the oil phase to form a pre-emulsion;
(iv) homogenising the pre-emulsion to form an emulsion concentrate;
(v) optionally drying the emulsion concentrate to form a dried nutritional com position.

In one embodiment, the oil is oat oil.

In one embodiment, the oat oil is prepared using low temperature high vacuum distillation, preferably at a pressure of between 0.001 to 0.03 mbar and a temperature of between 30° to 70° C.

In one embodiment, the oat oil is prepared using low temperature high vacuum distillation, preferably at a pressure of between 0.001 to 0.03 mbar and a temperature of between 30° to 50° C.

In one embodiment, the oat oil is prepared using low temperature high vacuum distillation, preferably at a pressure of between 0.001 to 0.03 mbar and a temperature of between 60° to 70° C.

In one embodiment, 0.5 to 30 wt %, 1 to 20 wt % or 2 to 15 wt % of the lipids in said composition are from oat oil, and at least 4%, at least 15%, at least 35% or at least 40 wt % of the oat oil lipids are polar lipids, wherein the polar lipids comprise one or more glycolipids.

According to another aspect of the present invention there is provided a method for processing oat oil comprising low temperature high vacuum distillation.

Preferably the processed oil has reduced odour, lighter colour and/or improved taste

### DETAILED DESCRIPTION

Polar Lipid Emulsifier

By an emulsifier is meant a compound that stabilises the interface between the two phases of the oil-in-water emulsion and reduces the rate of phase separation. For example an emulsifier may be a surfactant.

The polar lipids used in the present invention act as emulsifiers.

Preferably at least 0.005 wt % of the lipids in the nutritional composition are polar lipids.

In one embodiment, at least at least 0.01 wt %, at least 0.05 wt %, at least 0.1 wt %, at least 1.0 wt %, at least 2.0 wt % or at least 3.0 wt % of the lipids in the nutritional composition are polar lipids.

In one embodiment, 0.005 to 15 wt % of the lipids in the nutritional composition are polar lipids.

For example, 0.01 to 15 wt %, 0.05 to 15 wt %, 0.1 to 15 wt %, 0.5 to 15 wt %, 1 to 15 wt %, 2 to 15 wt %, 0.01 to 12 wt %, 0.05 to 12 wt %, 0.1 to 12 wt %, 0.5 to 12 wt %, 1 to 12 wt %, 2 to 12 wt %, 0.01 to 10 wt %, 0.05 to 10 wt %, 0.1 to 10 wt %, 0.5 to 10 wt %, 1 to 10 wt %, 2 to 10 wt %, 0.01 to 8 wt %, 0.05 to 8 wt %, 0.1 to 8 wt %, 0.5 to 8 wt %, 1 to 8 wt %, or 0.2 to 8 wt % of the lipids in said composition may be polar lipids.

Preferably at least 15, 20, 25, 30, 35, 40, 45, 50, 55 or 60 wt % of the polar lipids are glycolipids.

Preferably at least 5, 10, 15, 20 or 25 wt % of the polar lipids are digalactosyldiacylglycerides.

The polar lipids may also comprise phospholipids.

In one embodiment, less than 85, 80, 60, 40, 20, 15, 10, 8, 6, 4 or 2 wt % of the polar lipids are phospholipids.

Preferably the polar lipids comprise at least 15 wt % phospholipids. In one embodiment, the polar lipids comprise at least 15, 16, 17, 18, 19 or 20 wt % phospholipids.

For example, the polar lipids may comprise 15 to 85 wt % phospholipids or 20 to 80 wt % phospholipids.

In one embodiment the lipids may comprise glycolipids and phospholipids at a weight ratio of at least 1:5 glycolipids to phospholipids, for example at least 1:4, at least 1:3, at least 1:2 or at least 1:1.5. The lipids may comprise glycolipids and phospholipids at a weight ratio of 1:5 to 3:1, for example about 1:4 to 2:1 or 1:3 to 1:1.

The polar lipids may also comprise one or more of monogalactosylmonoglyceride, monogatactosyldiglyceride, digalactosylmonoglycerides or sterylglucoside.

The polar lipids may be derived from oat, spinach or sweet potato. Preferably the polar lipids are derived from oat.

Examples of polar lipids that can be used in the invention are the following oat oils: SWEOAT Oil PL4, SWEOAT Oil PL15 or SWEOAT Oil PL40.

SWEOAT Oil PL4 comprises the following per 100 grams: Fat 99 g, comprising 4 g of polar lipids and 95 g of neutral lipids; saturated fatty acids 17 g; monounsaturated fatty acids 37 g, polyunsaturated fatty acids 45 g.

SWEOAT Oil PL15 comprises the following per 100 grams: Fat 97 g, comprising 15 g of polar lipids and 82 g of neutral lipids; saturated fatty acids 17 g; monounsaturated fatty acids 37 g; polyunsaturated fatty acids 45 g.

SWEOAT Oil PL40 comprises the following per 100 grams: Fat 98 g, comprising 40 g of polar lipids and 58 g of neutral lipids.

In one embodiment, oat oil may comprise the following per 100 grams: Fat 97 to 99 g, comprising 4 to 40 g of polar lipids and 58 to 95 g of neutral lipids.

Low Temperature High Vacuum Distillation

In one embodiment, the polar lipid is oat oil, spinach oil or sweet potato oil which has been processed using low temperature high vacuum distillation. In one embodiment, the polar lipid is oat oil which has been processed using low temperature high vacuum distillation.

It is known that oil blends created with oat oil extract have: i) a strong negative odour, ii) a strong dark colour and iii) an off-taste. These are undesirable properties that make products prepared using an oat based oil blend un-appealing to consumers. Therefore it is preferable that oat oil is refined prior to use to remove contaminants that adversely impact the appearance and performance.

The bleaching of edible oils and fats is a part of the refining process of crude oils and fats and is generally preceded by degumming and neutralization processes. Bleaching is required to remove specific detrimental contaminants that are not effectively removed by these processes before the oil progresses through deodorisation.

Processes for carrying out degumming, bleaching, deodorisation and fractionation are well known in the art.

Deodorisation is a stripping process in which a given amount of a stripping agent (usually steam) is passed for a given period of time through hot oil at a low pressure. Hence, it is mainly a physical process in which various volatile components are removed.

Existing solutions to deodorising/decolouring of oils consist of standard bleaching and deodorising at elevated temperatures (e.g., 230-260° C.). However, the present inventors have found that these temperature lead to the creation of a black pigment/gum which leads to spoilage of the oil blend. This pigment also leads to the creation of a burn/caramel aroma/taste which is un-appealing.

The inventors have surprisingly found that using low temperature high vacuum distillation for deodorising/decolouring leads to an oat based oil blend that has no odour, dark colour or off-taste.

Low temperature high vacuum distillation is a method of distillation performed under reduced pressure. A reduced pressure decreases the boiling point of compounds, allowing for a reduced temperature to be used. This is advantageous if the desired compounds are thermally unstable and decompose at elevated temperatures. The present inventors have surprisingly shown that the oat oil blend contains compounds which are thermally unstable and formed black pigment/gum when standard bleaching and deodorising was carried out at elevated temperatures. However, the inventors have shown that this can be avoided by using low temperature high vacuum distillation.

Accordingly, low temperature high vacuum distillation may be used to efficiently produce an oil blend that has no odour, dark colour or off-taste.

In one embodiment, the polar lipid is oat oil, spinach oil or sweet potato oil which has been processed using low temperature high vacuum distillation. In one embodiment, the polar lipid is oat oil which has been processed using low temperature high vacuum distillation.

Preferably the low temperature high vacuum distillation is low temperature high vacuum distillation.

In one embodiment, the pressure is 0.001 to 0.03 mbar and temperature is 30° to 70° C.

In one embodiment, the pressure is 0.001 to 0.03 mbar and temperature is 30° to 50° C.

In one embodiment, the pressure is 0.001 to 0.03 mbar and temperature is 60° to 70° C.

In one embodiment, the low temperature high vacuum distillation is low temperature high vacuum thin film distillation.

Nutritional Composition

The expression “nutritional composition” means a composition which nourishes a subject.

The nutritional composition according to the invention can be, for example, a dietary supplement, a maternal food composition, an infant formula or a follow-on formula. The nutritional composition comprises a fat component and an aqueous component which may optionally contain proteins, carbohydrates and minerals/vitamins. The nutritional composition may be in liquid form. In one embodiment, the nutritional composition is in powder form for reconstitution with water.

Women's nutrient needs increase during pregnancy and lactation. If the increased nutrient needs are satisfied this protects maternal and infant health. Lactation is demanding on maternal stores of energy, protein, and other nutrients that need to be established, and replenished. Maternal food compositions are food compositions designed to help meet the specific nutritional requirements of women during pregnancy and lactation.

The nutritional composition according to the invention is preferably for oral administration. The administration may involve the use of a tube through the oro/nasal passage or a tube in the belly leading directly to the stomach. This may be used especially in hospitals or clinics.

The term “dietary supplement” refers to a supplement which may be used to complement the nutrition of an individual.

This nutritional composition may include a lipid (for example fat) source and a protein source. It may also contain a carbohydrate source. In one embodiment, the nutritional composition contains a lipid (for example fat) source with a protein source, a carbohydrate source or both.

“Soluble calcium” as used herein refers to calcium that is soluble in water and is present as either a free ionic species (free calcium) or chelated by another molecule (chelated calcium).

For example, the source of the calcium may be such that when present in water at 20° C., at least 0.5 mmol/L of the calcium is present as soluble calcium (free calcium or chelated calcium).

The source of soluble calcium may be selecting from one or more of the group consisting of calcium citrate, calcium hydroxide, calcium oxide, calcium chloride, calcium carbonate, calcium gluconate, calcium phosphate, calcium diphosphate, calcium triphosphate, calcium glycerophosphate, calcium lactate, and calcium sulphate.

In one embodiment, the soluble calcium is present of at least 10 to 120% of the ESPHGAN range for infant formula (ie. 50 and 140 mg/100 kcal), for example between 5 to 180 mg/100 kcal, 5 to 160 mg/100 kcal, 5 to 140 mg/100 kcal, 5 to 100 mg/100 kcal, 5 to 75 mg/100 kcal, 5 to 50 mg/100 kcal, 10 to 140 mg/100 kcal, 20 to 140 mg/100 kcal, 30 to 140 mg/100 kcal, 40 to 140 mg/100 kcal, or 50 to 140 mg/100 kcal.

In one embodiment, the nutritional composition comprises least 0.5, 1, 2, 3, 4 or 5 mmol/L of soluble calcium.

In one embodiment, the nutritional composition is a beverage. The composition may be a nutritionally complete formula, for example including a source of protein, carbohydrate and fat.

Protein sources based on, for example, whey, casein and mixtures thereof may be used as well as protein sources based on soy. As far as whey proteins are concerned, the protein source may be based on acid whey or sweet whey or mixtures thereof and may include alpha-lactalbumin and beta-lactoglobulin in any desired proportions. In some embodiments the protein source is whey predominant (i.e. more than 50% of proteins are coming from whey proteins, such as 60%> or 70%>). The proteins may be intact or hydrolysed or a mixture of intact and hydrolysed proteins

The nutritional composition according to the present invention may contain a carbohydrate source. This is particularly preferable in the case where the nutritional composition of the invention is an infant formula. In this case, any carbohydrate source conventionally found in infant formulae such as lactose, sucrose, saccharose, maltodextrin, starch and mixtures thereof may be used although one of the preferred sources of carbohydrates is lactose.

Lipid sources based on vegetable oils, animal fats, milk fat, fish oil, algal oil, canola oil, almond butter, peanut butter, palm fat, corn oil and/or high-oleic acid sunflower oil and/or interesterified fats such as betapol or the like may be used.

If the nutritional composition includes a lipid source, the lipid source has the advantage that, for example, an improved mouth feel can be achieved. Any lipid source is suitable. For example, animal or plant fats may be used. To increase the nutritional value, ω-3-unsaturated and ω-3-unsaturated fatty acids may be comprised by the lipid source. The lipid source may also contain long chain fatty acids and/or medium chain fatty acids.

In one embodiment, the total lipids in the composition is from 1 to 8 g/100 kcal.

The nutritional composition of the invention may also contain all vitamins and minerals understood to be essential in the daily diet and in nutritionally significant amounts. Minimum requirements have been established for certain vitamins and minerals. Examples of minerals, vitamins and other nutrients optionally present in the composition of the invention include vitamin A, vitamin B1, vitamin B2, vitamin B6, vitamin B12, vitamin E, vitamin K, vitamin C, vitamin D, folic acid, inositol, niacin, biotin, pantothenic acid, choline, calcium, phosphorous, iodine, iron, magnesium, copper, zinc, manganese, chlorine, potassium, sodium, selenium, chromium, molybdenum, taurine, and L-carnitine. Minerals are usually added in salt form. The presence and amounts of specific minerals and other vitamins will vary depending on the intended population.

The nutritional composition of the invention comprises a polar lipid as described herein as an emulsifier. While further emulsifiers are not necessary, in some embodiments, the nutritional composition may contain additional emulsifiers and stabilisers such as soy lecithin and/or citric acid esters of mono-diglycerides, and the like.

The nutritional composition of the invention may also contain other substances which may have a beneficial effect such as lactoferrin, osteopontin, TGFbeta, sIgA, glutamine, nucleotides, nucleosides, and the like. In one embodiment, the nutritional composition of the invention does not comprise any emulsifiers or stabilisers such as soy lecithin and/or citric acid esters of mono- and diglycerides.

In one embodiment, the only non-proteinaceous surface active emulsifier present in the creamer composition may be the polar lipid component referred to herein. In one embodiment the only surface active emulsifier present in the creamer composition is the polar lipid component referred to herein, and sodium caseinate.

The composition of the invention can further comprise at least one non-digestible oligosaccharide (e.g. prebiotics). They are usually in an amount between 0.3 and 10% by weight of a composition.

Prebiotics are usually non-digestible in the sense that they are not broken down and absorbed in the stomach or small intestine and thus remain intact when they pass into the colon where they are selectively fermented by the beneficial bacteria. Examples of prebiotics include certain oligosaccharides, such as fructooligosaccharides (FOS), inulin, xylooligosaccharides (XOS), polydextrose or any mixture thereof. In a particular embodiment, the prebiotics may be fructooligosaccharides and/or inulin. An example is a combination of 70% short chain fructooligosaccharides and 30% inulin, which is registered by Nestle under the trademark “Prebio 1”.

The composition of the present invention can further comprise at least one probiotic (or probiotic strain), such as a probiotic bacterial strain.

The probiotic microorganisms most commonly used are principally bacteria and yeasts of the following genera: Lactobacillus spp., Streptococcus spp., Enterococcus spp., Bifidobacterium spp. and Saccharomyces spp.

The nutritional composition according to the invention may be prepared in any suitable manner. For example, a composition may be prepared by blending together the protein source, the carbohydrate source and the fat source containing the polar lipid, in appropriate proportions. Any lipophilic vitamins, emulsifiers and the like may be dissolved into the fat source prior to blending. Commercially available liquefiers may be used to form the liquid mixture. Any oligosaccharides may be added at this stage, especially if the final product is to have a liquid form. If the final product is to be a powder, they may likewise be added at this stage if desired. The liquid mixture may then be homogenised.

Infant Formula

In a preferred embodiment, the nutritional composition is an infant formula or follow-on formula.

The expression “infant formula” means a foodstuff intended for particular nutritional use by infants during the first four to six months of life and satisfying by itself the nutritional requirements of this category of person (Article 1.2 of the European Commission Directive 91/321/EEC of May 14, 1991 on infant formulae and follow-on formulae).

The expression “starter infant formula” means a foodstuff intended for particular nutritional use by infants during the first four months of life.

The expression “follow-on formula” means a foodstuff intended for particular nutritional use by infants aged over four months and constituting the principal liquid element in the progressively diversified diet of this category of person.

The infant formula or follow-on formula of the invention preferably includes all the ingredients that are required for the infant, including but not limited to certain vitamins, minerals, and essential amino acids.

Typically, an infant formula in a ready-to-consume liquid form (for example reconstituted from a powder) provides 60-70 kcal/100 ml. Infant formula typically comprises, per 100 Kcal: about 1.8-4.5 g protein; about 3.3-6.0 g fat (lipids); about 300-1200 mg linoleic acid; about 9-14 g carbohydrates selected from the group consisting of lactose, sucrose, glucose, glucose syrup, starch, maltodextrins and maltose, and combinations thereof; and essential vitamins and minerals. Lactose may be the pre-dominant carbohydrate in an infant formula. For example, a liquid infant formula may contain about 67 kcal/100 ml. In some embodiments, infant formula may comprise about 1.8-3.3 g protein per 100 Kcal.

The infant formula or follow-on formula of the invention may be in the form of a ready-to-feed liquid, or may be a liquid concentrate or powdered formula that can be reconstituted into a ready-to-feed liquid by adding an amount of water that results in a liquid having, for example, about 60-70 kcal/100 ml.

The infant or follow-on formula of the invention comprises a source of protein. Such protein source can, for example, deliver between 1.6.cand 3 g protein/100 kcal. In one embodiment intended for premature infants, such amount can be between 2.4 and 4 g/100 kcal or more than 3.6 g/100 kcal. In one embodiment, the amount can be below 2.0 g per 100 kcal, e.g. in an amount below 1.8 g per 100 kcal.

The type of protein is not believed to be of highest criticality to the present invention provided that the minimum requirements for essential amino acid content are met and satisfactory growth is ensured. However particular proteins can provide a most suitable substrate for the microbiota. Thus, protein sources based on whey, casein and mixtures thereof may be used as well as protein sources based on soy. As far as whey proteins are concerned, the protein source may be based on acid whey or sweet whey or mixtures thereof and may include alpha-lactalbumin and beta-lactoglobulin in any desired proportions.

In one embodiment, the protein source is whey predominant (more than 50% of proteins are coming from whey proteins).

The proteins may be intact or hydrolysed or a mixture of intact and hydrolysed proteins. By the term “intact” is meant that the main part of the proteins are intact, i.e. the molecular structure is not altered, for example, at least 80% of the proteins are not altered, such as at least 85% of the proteins are not altered, at least 90% of the proteins are not altered, or at least 95% of the proteins are not altered, such as at least 98% of the proteins are not altered. In a particular embodiment, 100% of the proteins are not altered.

The term “hydrolysed” means a protein which has been hydrolysed or broken down into its component amino acids. The proteins may be either fully or partially hydrolysed. It may be desirable to supply partially hydrolysed proteins (degree of hydrolysis between 2 and 20%), for example, for infants believed to be at risk of developing cow's milk allergy. If hydrolysed proteins are required, the hydrolysis process may be carried out as desired and as is known in the art. For example, whey protein hydrolysates may be prepared by enzymatically hydrolysing the whey fraction in one or more steps. If the whey fraction used as the starting material is substantially lactose free, it is found that the protein suffers much less lysine blockage during the hydrolysis process. This enables the extent of lysine blockage to be reduced from about 15% by weight of total lysine to less than about 10% by weight of lysine;

for example about 7% by weight of lysine which greatly improves the nutritional quality of the protein source.

In an embodiment of the invention at least 70%, 80%, 90%, 95% or 98% of the proteins are hydrolysed. In one embodiment, 100% of the proteins are hydrolysed. In one embodiment, the hydrolyzed proteins are the sole source of protein.

In one embodiment, the infant formula or follow-on formula comprises alpha-lactalbumin in an amount of at least 0.2 or 0.3 or 0.4 g/100 kcal or at least 1.7 g, or 2.0 or 2.3, or 2.6 g/L. The presence of alpha-lactalbumin in a certain amount is believed to enhance the effect of oligofructose by providing, for example, an adequate nutritional substrate to the microbiota.

An infant formula or follow-on formula may comprise nucleotides selected from cytidine 5′-monophosphate (CMP), uridine 5′-monophosphate (UMP), adenosine 5′-monophosphate (AMP), guanosine 5′-monophosphate (GMP) and inosine 5′-monophosphate (IMP), and mixtures thereof. Infant formula may also comprise lutein, zeaxanthin, fructo-oligosaccharides, galacto-oligosaccharides, sialyl-lactose, and/or fucosyl-lactose. Long chain polyunsaturated fatty acids, such as docosahexaenoic acid (DHA) and arachidonic acid (AA) may be included in the formula.

The infant formula or follow-on formula can also comprise further non-digestible oligosaccharides (e.g. prebiotics). They are usually in an amount between 0.3 and 10% by weight of composition.

### EXAMPLES

### Example 1—a Complete Nutritional Drink

A complete nutritional drink was prepared by mixing two liquid concentrates (oil phase and water phase) to create a 100 kg concentrate (Composition in Table 1.1 below).

The water phase was prepared by mixing 77.75 kg of water, 4.9 kg of skim milk powder, 4.15 kg of sucrose, 3.1 kg of soy protein isolate, 2.85 kg corn syrup solids, 1.64 kg of low fat cocoa powder, 1 kg of calcium caseinate, 1 kg of sodium caseinate, 350 grams of potassium citrate, 60 grams of sodium carboxymethyl cellulose, 20 grams carrageenan and a mineral mix containing up to 30 minerals and vitamins at 60° C.

The oil phase was prepared by mixing 2 kg of rapeseed oil (low erucic acid) with 450 grams of oat oil.

The oil phase was then incorporated into the water mix under high agitation for 5 minutes.

This mixture was then heated to 80° C. for 5 minutes, homogenised at 250/50 bar and spray dried to obtain a powder.

The composition of the final drink is in Table 1.1 below.

TABLE 1.1
Composition of Complete Nutritional Drink

| Ingredient | per 100 mL | |
|---|---|---|
| Energy | 91.2 | kcal |
| Protein | 9.3 | g |
| Carbohydrates | 8 | g |
| Fat | 2.5 | g |
| Cocoa powder | 1.63 | g |
| Oat Oil | 0.450 | g |
| Calcium | 148 | mg |
| Iron | 1.9 | mg |

| | |
|---|---|
| Other vitamins & minerals | as needed |

### Example 2—Infant Feeding Formula or Follow on Milk

A liquid infant formula containing extensively hydrolyzed protein was created by dissolving the protein and lactose in solution and conducting hydrolysis of the protein using enzymes known in the art (for example alcalase, trypsin and/or others). After enzymatic hydrolysis was terminated, the fat phase containing 0.1-15 wt % oat oil (including 5-50 wt % polar lipids within) was added using an inline mixing pump. A coarse emulsion was created by passing this mixture through a high pressure homogenizer (250/50 bar). The remaining vitamins and minerals were added and pH standardised in a buffer tank. The complete mixture (as per Table 2.1) was then passed through a UHT/homogenization unit subjecting at 141° C. for ˜3 seconds. A finished liquid or powdered infant formula product was produced either by; i) aseptically filling this liquid into glass bottles, plastic pouches, cartons and/or foil pouches or ii) spray drying the liquid and filling into tins.

The composition of the final infant formula is in Table 2.1 below.

The resulting liquid infant formula had exceptional calcium stability remaining as discrete individual emulsion droplets and not forming a cream layer.

TABLE 2.1
Composition of Infant feeding formula or follow on milk.

| Nutrient | Per 100 kcal |
|---|---|
| Energy (kcal) | 100 |
| Protein (g) | 1.8-2.1 |
| Lactose (g) | 9.0-14.0 |
| Fat (g) | 4.4-6.0 |
| Oat Oil (g) | 0.044-0.9 |
| Calcium (mg) | 50.0-140.0 |
| Iron (mg) | 0.4-8.0 |
| Other minerals | As needed |

Various preferred features and embodiments of the present invention will now be described with reference to the following numbered paragraphs (paras).

1. A nutritional composition comprising soluble calcium, wherein 0.01 to 20 wt % of the lipids in said composition are polar lipids, wherein the polar lipids comprise a glycolipid.

2. A nutritional composition according to para 1 wherein at least 0.01 wt %, at least 0.05 wt %, at least 0.1 wt %, at least 1 wt % or at least 2 wt % of the lipids in said nutritional composition are polar lipids, wherein the polar lipids comprise a glycolipid.

3. A nutritional composition according to any preceding para wherein the polar lipids are derived from oat, spinach or sweet potato.

4. A nutritional composition comprising soluble calcium, wherein 0.1 to 30 wt % of the lipids in said composition are from oat oil, and wherein at least 4%, at least 15%, at least 35% or at least 40% by weight of the oat oil lipids are polar lipids, wherein the polar lipids comprise a glycolipid.

5. A nutritional composition according to any preceding para wherein at least 20 wt % of the polar lipids are galactolipids, preferably wherein at least 20 wt % of the polar lipids are digalactosyldiacylglycerides.

6. A nutritional composition according to any preceding para wherein the polar lipids also comprise phospholipids.

7. A nutritional composition according to any one of paras 3 to 6 wherein the oat oil is processed using low temperature high vacuum distillation, at a pressure of between 0.001 to 0.03 mbar and a temperature of between 30° to 70° C.

8. A nutritional composition according to any one of para 7 wherein the oat oil is processed using low temperature high vacuum distillation, at a pressure of between 0.001 to 0.03 mbar and a temperature of between 30° to 50° C.

9. A nutritional composition according to any one of para 7 wherein the oat oil is processed using low temperature high vacuum distillation, at a pressure of between 0.001 to 0.03 mbar and a temperature of between 60° to 70° C.10. A nutritional composition according to any preceding para wherein the soluble calcium is selected from the group consisting of calcium citrate, calcium hydroxide, calcium oxide, calcium chloride, calcium carbonate, calcium gluconate, calcium phosphate, calcium diphosphate, calcium triphosphate, calcium glycerophosphate, calcium lactate, and calcium sulphate

11. A nutritional composition according to any preceding para, wherein the soluble calcium is present in an amount of at least 0.01 wt %, such as 0.01 to 0.5 wt %, 0.075 to 0.25 wt % or 0.1 to 0.2 wt %, or wherein the soluble calcium is present in an amount of between 5 to 180 mg/100 kcal, 5 to 160 mg/100 kcal, 5 to 140 mg/100 kcal, 5 to 100 mg/100 kcal, 5 to 75 mg/100 kcal, 5 to 50 mg/100 kcal, 10 to 140 mg/100 kcal, 20 to 140 mg/100 kcal, 30 to 140 mg/100 kcal, 40 to 140 mg/100 kcal or 50 to 140 mg/100 kcal.

12. A nutritional composition according to any preceding para wherein the nutritional composition comprises no additional emulsifiers.

13. A nutritional composition according to any preceding para wherein the total amount of lipids in the composition is from 1 to 8 g/100 kcal, the total amount of protein in the composition is from 1 to 12 g/100 kcal and/or the total amount of carbohydrate in the composition is from 8 to 20 g/100 kcal.

14. A nutritional composition according to any preceding para wherein the nutritional composition is an infant formula or a follow-on formula.

15. An infant formula or follow-on formula according to para 14 wherein the total amount of lipids in the infant formula is from 4.4 to 6.0 g/100 kcal, the total amount of protein in the infant formula is from 1.6 to 4 g/100 kcal and/or the total amount of carbohydrate in the infant formula is from 9 to 14 g/100 kcal.

16. Use of polar lipids comprising a glycolipid as an emulsifier in a nutritional composition, preferably wherein at least 20 wt % of the polar lipids are digalactosyldiacylglycerides.

17. Use according to para 16 wherein the polar lipids are derived from oat, spinach or sweet potato.

18. Use of oat oil as an emulsifier in a nutritional composition, preferably wherein at least 4%, at least 15%, at least 35% or at least 40 wt % of the oat oil lipids are polar lipids, more preferably wherein at least 20 wt % of the polar lipids are digalactosyldiacylglycerides.

19. Use according to para 18 where the oat oil is prepared by low temperature high vacuum distillation.

20. Use according to para 19, wherein a pressure of between 0.001 to 0.03 mbar and a temperature of between 30° to 70° C. is used.

21. Use according to para 20, wherein a pressure of between 0.001 to 0.03 mbar and a temperature of between 30° C. and 50° C. is used.

22. Use according to para 20, wherein a pressure of between 0.001 to 0.03 mbar and a temperature of between 60° C. and 70° C. is used.

23. Use according to any one of paras 14 to 22, wherein the polar lipids or oat oil are used to reduce acid instability of the nutritional composition.

24. A method for processing oat oil comprising low temperature high vacuum distillation.

25. A method according to para 24, wherein a pressure of between 0.001 to 0.03 mbar and a temperature of between 30° C. to 70° C. is used.

26. Method according to para 25, wherein a pressure of between 0.001 to 0.03 mbar and a temperature of between 30° C. and 50° C. is used.

27. Method according to para 25, wherein a pressure of between 0.001 to 0.03 mbar and a temperature of between 60° C. and 70° C. is used.

28. The method of paras 24 to 27 wherein the processed oil has reduced odour, lighter colour and/or improved taste.

1. A nutritional composition comprising soluble calcium, wherein 0.01 to 20 wt % of the lipids in said composition are polar lipids, wherein the polar lipids comprise a glycolipid.

2. A nutritional composition according to claim 1 wherein at least 0.01 wt % of the lipids in the nutritional composition are polar lipids, wherein the polar lipids comprise a glycolipid.

3. A nutritional composition according to claim 1 wherein the polar lipids are derived from oat, spinach or sweet potato.

4. A nutritional composition comprising soluble calcium, wherein 0.1 to 30 wt % of the lipids in the composition are from oat oil, and wherein at least 4% by weight of the oat oil lipids are polar lipids, wherein the polar lipids comprise a glycolipid.

5. A nutritional composition according to claim 1 wherein at least 20 wt % of the polar lipids are galactolipids.

6. A nutritional composition according to claim 1 wherein the polar lipids also comprise phospholipids.

7. A nutritional composition according to claim 4 wherein the oat oil is processed using low temperature high vacuum distillation.

8. A nutritional composition according to claim 1 wherein the soluble calcium is selected from the group consisting of calcium citrate, calcium hydroxide, calcium oxide, calcium chloride, calcium carbonate, calcium gluconate, calcium phosphate, calcium diphosphate, calcium triphosphate, calcium glycerophosphate, calcium lactate, and calcium sulphate

9. A nutritional composition according to claim 1, wherein the soluble calcium is present in an amount of at least 0.01 wt %.

10. A nutritional composition according to claim 1 wherein the nutritional composition comprises no additional emulsifiers.

11. A nutritional composition according to claim 1 wherein the total amount of lipids in the composition is from 1 to 8 g/100 kcal, the total amount of protein in the composition is from 1 to 12 g/100 kcal and/or the total amount of carbohydrate in the composition is from 8 to 20 g/100 kcal.

12. A nutritional composition according to claim 1 wherein the nutritional composition is an infant formula or a follow-on formula.

13. An infant formula or follow-on formula according to claim 12 wherein the total amount of lipids in the infant formula is from 4.4 to 6.0 g/100 kcal, the total amount of protein in the infant formula is from 1.6 to 4 g/100 kcal and/or the total amount of carbohydrate in the infant formula is from 9 to 14 g/100 kcal.

14. A method for reducing the instability of acid in a nutritional formulation comprising using polar lipids comprising a glycolipid as an emulsifier in the nutritional composition.

15. A method according to claim 14 where the oat oil is prepared by low temperature high vacuum distillation.

16. A nutritional composition according to claim 4 wherein at least 20 wt % of the polar lipids are galactolipids.

17. A nutritional composition according to claim 4 wherein the soluble calcium is selected from the group consisting of calcium citrate, calcium hydroxide, calcium oxide, calcium chloride, calcium carbonate, calcium gluconate, calcium phosphate, calcium diphosphate, calcium triphosphate, calcium glycerophosphate, calcium lactate, and calcium sulphate

18. A nutritional composition according to claim 4, wherein the soluble calcium is present in an amount of at least 0.01 wt %.

19. A nutritional composition according to claim 4 wherein the total amount of lipids in the composition is from 1 to 8 g/100 kcal, the total amount of protein in the composition is from 1 to 12 g/100 kcal and/or the total amount of carbohydrate in the composition is from 8 to 20 g/100 kcal.

20. A nutritional composition according to claim 4 wherein the nutritional composition is an infant formula or a follow-on formula.
